(19) United States
(12) Patent Application Publication
(10) Pub. No.: US 2026/0238744 A1
(43) Pub. Date: Aug. 13, 2026

(54) INFORMATION PROCESSING DEVICE

(71) Applicants: TOYOTA JIDOSHA KABUSHIKI KAISHA, Toyota-shi (JP); DENSO TEN Limited, Kobe (JP)

(72) Inventors: Zhenqin Shi, Tokyo (JP); Akira Toyota, Kobe (JP); Ryosuke Matsuoka, Kobe (JP); Koichiro Takeuchi, Nagoya-shi (JP)

(73) Assignees: TOYOTA JIDOSHA KABUSHIKI KAISHA, Toyota-shi (JP); DENSO TEN Limited, Kobe (JP)

(21) Appl. No.: 19/423,015

(22) Filed: Dec. 17, 2025

(30) Foreign Application Priority Data
Jan. 24, 2025 (JP) 2025-010892

(51) Int. Cl. H04N 7/18; H04N 23/65; H04N 23/661; B60R 25/30

(52) U.S. Cl. CPC H04N 7/181; H04N 23/651; H04N 23/661; B60R 25/305

(57) ABSTRACT

An information processing device includes a communication unit that communicates with a plurality of vehicles, each of which is capable of capturing images of surroundings thereof, and a control unit that, when the vehicles are parked in a predetermined site, causes a first vehicle that satisfies conditions for carrying out monitoring, to carry out image capturing, and sends an instruction to cause a second vehicle that does not satisfy the conditions to stop capturing images.

### CROSS-REFERENCE TO RELATED APPLICATION

This application claims priority to Japanese Patent Application No. 2025-010892 filed on Jan. 24, 2025. The disclosure of the above-identified application, including the specification, drawings, and claims, is incorporated by reference herein in its entirety.

### BACKGROUND

### 1. Technical Field

The present disclosure relates to an information processing device.

### 2. Description of Related Art

Image capturing means for capturing images of a vicinity of a vehicle when a theft or the like occurs in a parked vehicle, such as a drive recorder device or the like, are known for verifying situations in the vicinity after the fact. For example, Japanese Unexamined Patent Application Publication No. 2020-150295 (JP 2020-150295 A) discloses technology for compositing and displaying captured images that are captured by a plurality of cameras installed in a vehicle.

### SUMMARY

There is room for optimizing resources for monitoring of surroundings of vehicles.

An information processing device and the like, that enables further optimizing of monitoring the vicinity of a vehicle, is disclosed below.

An information processing device according to the present disclosure includes a communication unit that communicates with a plurality of vehicles, each of which is configured to capture images of surroundings, and a control unit that, when the vehicles are parked in a predetermined site, sends an instruction to cause a first vehicle that satisfies conditions for carrying out monitoring to carry out image capturing, and to cause a second vehicle that does not satisfy the conditions to stop image capturing.

According to the information processing device and the like according to the present disclosure, monitoring of the vicinity of a vehicle can be further optimized.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a configuration of an information providing system; and

FIG. 2 is a sequence diagram showing an example of operation procedures of the information providing system.

### DETAILED DESCRIPTION OF EMBODIMENTS

An embodiment will be described below with reference to the drawings.

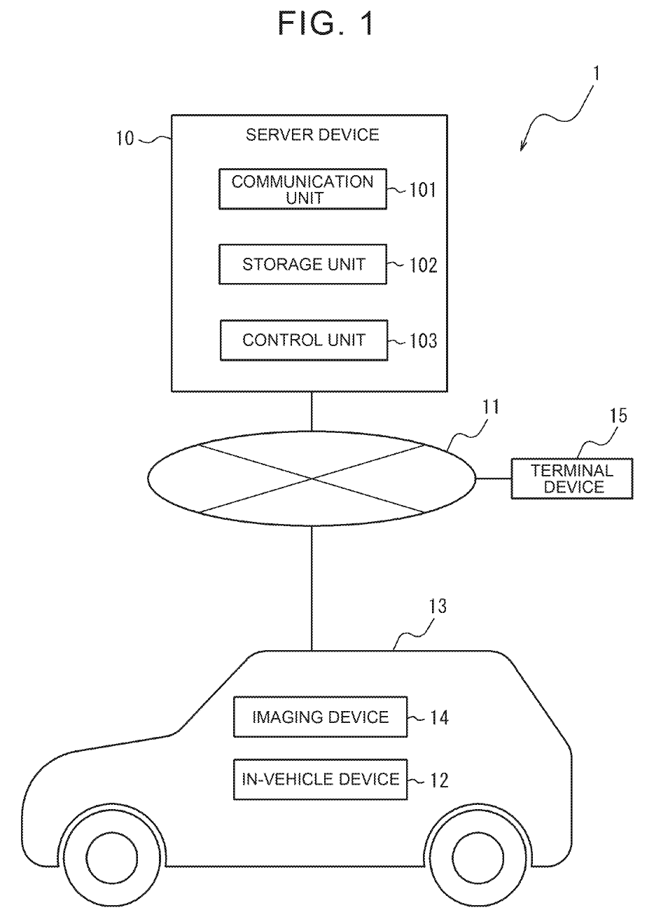

FIG. 1 is a diagram illustrating an example of a configuration of a vehicle control system according to an embodiment. A vehicle control system 1 includes one or more server devices 10, two or more in-vehicle devices 12, and one or more terminal devices 15, which are connected to each other via a network 11 so as to be capable of communicating information with each other. The server device 10 corresponds to an "information processing device" in the present embodiment, and is, for example, one or more server computers that belong to a cloud computing system or some other computing system and function as a server that implements various types of functions. The in-vehicle device 12 is installed in each of two or more vehicles 13. The vehicle 13 may be a passenger automobile, a commercial vehicle, or the like, and may be an internal combustion engine vehicle, a hybrid electric vehicle, a plug-in hybrid electric vehicle, or the like. The in-vehicle device 12 is a computer that has a communication function and an information processing function, and that controls operations of the vehicle 13 and operations of an imaging device 14 installed in the vehicle 13. The imaging device 14 is a so-called drive recorder device, and has a digital camera and a control circuit thereof installed at a position from which images of at least a vicinity of outside of the vehicle 13 can be captured, and operates by receiving supply of power from a battery installed in the vehicle 13. The terminal device 15 is an information processing device equipped with communication functions, examples of which include a personal computer, a smartphone, and so forth. The network 11 may be, for example, a mobile communication network, the Internet, an ad-hoc network, a local area network (LAN), a metropolitan area network (MAN), some other network, or any combination thereof.

The server device 10 in the present embodiment includes a communication unit 101 and a control unit 103. The communication unit 101 communicates with a plurality of the vehicles 13, each of which is capable of capturing images of surroundings thereof. When multiple vehicles 13 are parked in a predetermined site (hereinafter referred to as "object site"), the control unit 103 causes a first vehicle 13 that satisfies conditions for carrying out monitoring (hereinafter referred to as "monitoring conditions") to carry out image capturing, and sends an instruction to a second vehicle 13 that does not satisfy the monitoring conditions to stop performing image capturing (hereinafter referred to as "vehicle 13-A" and "vehicle 13-B", respectively, when distinguishing between first and second vehicles 13). Here, the object site is any site at which multiple vehicles 13 can be parked, such as a parking lot, an expressway rest area, or the like. The vehicle 13-A that satisfies the monitoring conditions sends captured images of the object site to the server device 10 at an optional cycle, and accordingly the captured images are stored in the server device 10. The captured images stored in the server device 10 are acquired by the terminal device 15 in the event of onsite investigations and the like, and can be viewed by an operator using the terminal device 15.

When multiple vehicles 13 are parked in the object site, the likelihood of imaging capturing ranges of the multiple vehicles 13 overlapping will rise, and accordingly image capturing by all of the vehicles 13 will result in wasteful use of resources. In this regard, waste can be reduced by causing the vehicle 13-A that satisfies the monitoring conditions to carry out image capturing, and causing the other vehicle 13-B that does not satisfy the monitoring conditions to stop image capturing.

Monitoring conditions are that remaining battery charge of the vehicle 13 is at a criterion level or higher, or that supply of power can be received from an external power source that is situated outside of the vehicle 13. A criterion for the remaining battery charge is any State of Charge (SOC) value, for example, 50% to 60%. Alternatively, the criterion may be an average value, a maximum value, or any deviation value or the like, of the remaining battery charges of the vehicles 13. Also, the count of vehicles 13-A that satisfy the monitoring criterion may be multiple. In a vehicle 13 that is parked, the imaging device 14 is battery-powered and requires power to continue performing image capturing of the object site over a certain period of time, but setting the remaining battery charge or power supply from an external power source as a monitoring condition enables more reliable operation of the vehicle 13-A that is performing monitoring to be ensured. That is to say, monitoring of the vicinity the vehicle 13 can be further optimized.

Alternatively, monitoring conditions are that the count of other vehicles that are in the object site and of which images can be captured is equal to or greater than a certain criterion level. The criterion for the count of other vehicles is any count that is equal to or greater than 1 and less than N, for example, N-1, where N is the count (natural number) of the vehicles 13 parked in the object site. Also, the count of vehicles 13-A that satisfy the monitoring criterion may be multiple. A region over which images can be captured in the object site differs for each vehicle 13, due to the installation position of the imaging device 14 on the vehicle 13, the focal length and angle of view of the camera, the parked position of the vehicle 13, and so forth, but setting the monitoring conditions such that the count of other vehicles regarding which images can be captured in the object site is a criterion count or greater enables capturing images of and monitoring of more other vehicles 13 in the object site, using fewer vehicles 13. That is to say, monitoring of the vicinity the vehicle 13 can be further optimized.

An example of the configuration of the server device 10 will be described. The server device 10 includes a storage unit 102, in addition to the communication unit 101 and the control unit 103. The server device 10 may be one computer, or may be made up of two or more computers that are connected so as to be capable of information communication, and to perform coordinated operations. When the server device 10 is made up of two or more computers, the configuration illustrated in FIG. 1 is distributed among the two or more computers as appropriate.

The communication unit 101 includes one or more communication interfaces. Examples of the communication interface include a LAN interface. The communication unit 101 receives information to be used for operations of the control unit 103, and also transmits information obtained through operations of the control unit 103. The server device 10 is connected to the network 11 by the communication unit 101, and communicates information with the in-vehicle device 12, the terminal device 15, and so forth, via the network 11.

The storage unit 102 includes, for example, one or more semiconductor memory devices, one or more magnetic memory devices, one or more optical memory devices, or a combination of at least two thereof, so as to function as a main storage device, an auxiliary storage device, or cache memory. The semiconductor memory is, for example, random access memory (RAM) or read-only memory (ROM). The RAM is, for example, static RAM (SRAM) or dynamic RAM (DRAM). ROM is, for example, electrically erasable programmable ROM (EEPROM). The storage unit 102 stores information to be used for operations of the control unit 103 and information obtained through operations of the control unit 103.

The control unit 103 includes one or more processors, one or more dedicated circuits, or a combination thereof. The processor is, for example, a general-purpose processor such as a central processing unit (CPU) or the like, or a dedicated processor specialized for specific processing such as a graphics processing unit (GPU) or the like. The dedicated circuit is, for example, a field-programmable gate array (FPGA), an application-specific integrated circuit (ASIC), or the like. The control unit 103 carries out information processing related to operations of the server device 10 while controlling each unit of the server device 10.

The functions of the server device 10 are realized by the processor, which is included in the control unit 103, executing a control program. The control program is a program that causes a computer to carry out processing of steps included in the operations of the server device 10, and thus causes the computer to realize functions corresponding to the processing of the steps. That is to say, the control program is a program that causes the computer to function as the server device 10. Also, part or all of the functions of the server device 10 may be realized by the dedicated circuits included in the control unit 103. Also, the control program may be stored in a non-transitory recording/storage medium that can be read by the server device 10, and the server device 10 may read the control program from the medium.

A configuration of the in-vehicle device 12 will be described. The in-vehicle device 12 is made up of one or more control devices, a communication device, and other devices. The control device includes a microcomputer such as an electronic control unit (ECU) or the like. The control device has a user interface and is capable of receiving information input by user operations, outputting information obtained by information processing, and so forth. The communication device includes a data communication module (DCM) and so forth, and is configured to be connected to the network 11 by mobile communications so as to be able to communicate information with the server device 10 via the network 11. Also, the in-vehicle device 12 and various parts of the vehicle 13 are connected to each other so as to be able to communicate information with each other via an in-vehicle network conforming to a standard such as controller area network (CAN) or the like. The in-vehicle device 12 controls operations of the vehicle 13 by obtaining detection results from sensors, such as vehicle speed, acceleration, and so forth, of the vehicle 13, and controlling various actuators that carry out operations of the vehicle 13, and also controls operations of the imaging device 14 to obtain captured images from the imaging device 14. Further, the in-vehicle device 12 has one or more global navigation satellite system (GNSS) receivers, and acquires position information of the vehicle 13. Note that the in-vehicle device 12 may be configured to include, as a part thereof, an information processing device such as an automotive navigation system, a smartphone, a tablet terminal, or the like.

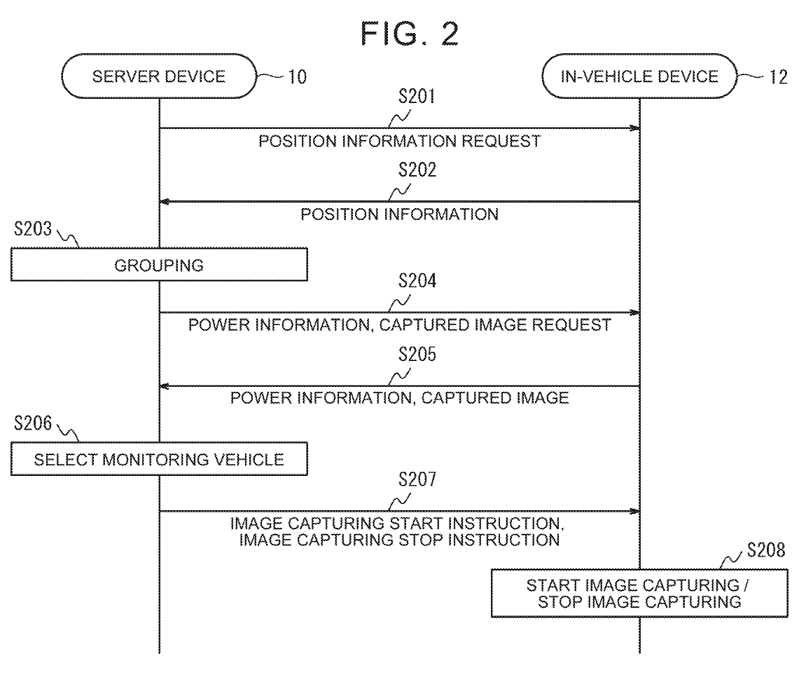

FIG. 2 is a sequence diagram for describing operation procedures of the vehicle control system 1 according to the present embodiment. FIG. 2 shows procedures for the coordinated operations of the server device 10, the in-vehicle device 12 of the vehicle 13, and the terminal device 15. Steps relating to various types of information processing of the server device 10 in FIG. 2 are carried out by the control unit 103. Also, steps relating to exchange of various types of information by the server device 10 are carried out by the control unit 103 exchanging information via the communication unit 101. In the server device 10, information to be processed, be referred to, or be exchanged, by the control unit 103, is stored in the storage unit 102 as appropriate. Also, operations of the vehicle 13 according to the present embodiment are realized by operations of the in-vehicle device 12 in FIG. 2.

In S201, the server device 10 requests the in-vehicle device 12 for position information. The server device 10 stores in advance, for example, identification information for each of the in-vehicle devices 12 necessary for exchanging information with one or more of cooperating in-vehicle devices 12. The server device 10 then sends information requesting the position information, to each of the in-vehicle devices 12, based on the identification information.

In S202, the in-vehicle device 12 responds to the request from the server device 10 by sending the position information to the server device 10.

S201 and S202 are carried out at optional cycles, such as every few minutes, for example.

In S203, the server device 10 groups multiple vehicles 13. Upon determining that a predetermined count of vehicles 13 have parked in a monitoring object site, based on the position information of each of the vehicles 13, the server device 10 groups the vehicles 13 parked in the monitoring object site. Based on map information that is stored in advance, the server device 10 determines that the vehicles 13 are parked when the positions of the vehicles 13 do not move for a certain period of time within the monitoring object site on the map. The server device 10 then stores the identification information of the vehicles 13 that are grouped, in association with each other.

In S204, the server device 10 requests the in-vehicle devices 12 of the vehicles 13 that are grouped, to provide either or both of power information and captured images. The power information is either or both of information regarding the remaining charge of the battery installed in the vehicle 13, and information indicating that there is external power supply.

In S205, in response to the request from the server device 10, the in-vehicle device 12 sends either or both of power information and captured images to the server device 10. For example, the in-vehicle device 12 acquires the remaining charge of the or the charging state of the battery installed in the vehicle 13 using a sensor, and sends the information regarding the remaining battery charge, or information indicating that there is an external power supply, to the server device 10. The in-vehicle device 12 also causes the imaging device 14 to capture images of the vicinity of the vehicle 13, and sends an optional count of frames of captured images to the server device 10.

In S206, the server device 10 selects the monitoring vehicle 13-A. The server device 10 selects a vehicle 13 that satisfies the monitoring conditions to be a vehicle 13-A, based on the captured images or power information that is collected from the vehicles 13 that are grouped. For example, the server device 10 selects a vehicle 13 that has a remaining battery charge equal to or greater than a criterion level, or is receiving supply of power from an external power source, to be the vehicle 13-A. Alternatively, the server device 10 selects a vehicle 13 regarding which the count of other vehicles that can be captured in images in the object site is equal to or greater than a criterion level, to be the vehicle 13-A. The server device 10 detects, from the captured images collected from each of the vehicles 13, the count of other vehicles captured in the images, by performing image processing such as pattern matching or the like. Alternatively, the server device 10 may select a vehicle 13 of which power information satisfies the criterion, and also captured images satisfy the criterion, to be the vehicle 13-A. Note that the server device 10 decides other vehicles 13 that are not selected to be the vehicle 13-A as being vehicles 13-B.

In S207, the server device 10 sends an image capturing start instruction to the vehicle 13-A, which meets the monitoring conditions and has been selected to be a monitoring vehicle, and an image capturing stop instruction to the vehicle 13-B, which does not satisfy the monitoring conditions and has not been selected as a monitoring vehicle.

In S208, the in-vehicle device 12 of the vehicle 13-A causes the imaging device 14 to start image capturing in response to the image capturing start instruction, and the in-vehicle device 12 of the vehicle 13-B causes the imaging device 14 to stop image capturing in response to the image capturing stop instruction. Thus, the vehicle 13-A starts capturing images of the object site, whereby monitoring for crime deterrence is carried out. On the other hand, stopping image capturing at the vehicle 13-B enables unnecessary power consumption to be reduced. Note that after the vehicle 13-A starts capturing images, direct crime deterrence activities such as impact detection and so forth are carried out in each of the vehicles 13-A and 13-B. For example, upon detecting an impact on a vehicle body, a window, or the like, by an acceleration sensor or the like, the in-vehicle device 12 carries out processing such as emitting an alarm or the like.

In a modification, the server device 10 stores information regarding a user of each of the vehicles 13 associated to the vehicle information, and performs processing of imparting an economic incentive to the user of the vehicle 13 that is selected to be the monitoring vehicle 13-A. This enables promoting a sense of satisfaction among users who have contributed to collective crime deterrence activities, including the vehicles 13-B.

According to the above-described operations of the vehicle control system 1, waste can be reduced by causing the vehicle 13-A that satisfies the monitoring conditions to carry out image capturing, and causing the other vehicles 13-B that do not satisfy the monitoring conditions to stop image capturing.

Although the embodiment has been described above based on the drawings and examples, it should be noted that those skilled in the art can easily make various modifications and alterations thereto based on the present disclosure. It should be noted, therefore, that such modifications and alterations fall within the scope of the present disclosure. For example, functions and so forth included in each means, each step, and so forth, can be rearranged such that no logical inconsistency arises, and multiple means, steps, and so forth can be combined into one or divided.

What is claimed is:

1. An information processing device comprising:
a communication unit that communicates with a plurality of vehicles, each of which is configured to capture images of surroundings; and
a control unit, upon determining that the vehicles are parked in a predetermined site, based on a position of each of the vehicles, sends an instruction to a first vehicle that satisfies any of conditions of remaining battery charge of the vehicle being at or above a criterion level, supply of external power from a power source outside the vehicle is receivable by the vehicle, and a count of other vehicles in the predetermined site that are capturable by imaging is at or above a criterion level, based on information from each of the vehicles, for causing the first vehicle to carry out image capturing, so as to carry out image capturing, and sending an instruction to a second vehicle that does not satisfy the above conditions to stop image capturing, causing the second vehicle to stop image capturing.

2. An information processing device, comprising
a communication unit that communicates with a plurality of vehicles, each of which is configured to capture images of surroundings; and
a control unit that, when the vehicles are parked in a predetermined site, causes a first vehicle that satisfies a condition for carrying out monitoring of the predetermined site to carry out image capturing, and sends an instruction to cause a second vehicle that does not satisfy the condition to stop image capturing.

3. The information processing device according to claim 2, wherein the condition is that remaining battery charge of a vehicle is at or above a criterion level, or supply of external power from a power source outside the vehicle is receivable by the vehicle.

4. The information processing device according to claim 2, wherein the condition is that a count of other vehicles in the predetermined site that are capturable by imaging is at or above a criterion level.

5. The information processing device according to claim 4, wherein the control unit determines whether the condition is satisfied, based on captured images of each of the vehicles.
